(19) United States
(12) Patent Application Publication
(10) Pub. No.: US 2010/0260390 A1
(43) Pub. Date: Oct. 14, 2010

(54) SYSTEM AND METHOD FOR REDUCTION OF FALSE POSITIVES DURING COMPUTER AIDED POLYP DETECTION

(75) Inventors: Jermoe Z. Liang, Stony Brook, NY (US); Zigang Wang, East Setauket, NY (US)

Correspondence Address: DORSEY & WHITNEY LLP;INTELLECTUAL PROPERTY DEPARTMENT, 250 PARK AVENUE, NEW YORK, NY, 10177, US

(73) Assignee: THE RESEARCH FOUNDATION OF STATE UNIVERSITY OF NEW YORK, STONY BROOK, NY (US)

(21) Appl. No.: 12/095,687

(22) PCT Filed: Nov. 29, 2006
(86) PCT No.: PCT/US06/46170

§ 371 Date: Jun. 7, 2010

Related U.S. Application Data
(60) Provisional application No. 60/741,496, filed on Nov. 30, 2005.

(51) Int. Cl. G06K 9/00

(52) U.S. Cl. 382/128

(57) ABSTRACT

A computer aided detection (CAD) method for detecting polyps within an identified mucosa layer of a virtual representation of a colon includes the steps of identifying candidate polyp patches in the surface of the mucosa layer and extracting the volume of each of the candidate polyp patches. The extracted volume of the candidate polyp patches can be partitioned to extract a plurality of features, of the candidate polyp patch, which includes at least one internal feature of the candidate polyp patch. The features can include density texture features, geometrical features, and morphological features of the polyp candidate volume. The extracted features of the polyp candidates are analyzed to eliminate false positives from the candidate polyp patches. Those candidates which are not eliminated are identified as polyps.

### STATEMENT OF PRIORITY AND RELATED APPLICATIONS

This application claims priority to U.S. Provisional Application 60/741,496 filed on Nov. 30, 2005, entitled Reduction of False Positives By Internal Features For Polyp Detection in CT-Based Virtual Colonoscopy, which is hereby incorporated by reference in its entirety.

### STATEMENT OF GOVERNMENT RIGHTS

This work has been supported in part by National Institutes of Health Grant CA082402 of the National Cancer Institute. The United States government may have certain rights to the invention described and claimed herein.

### BACKGROUND OF THE INVENTION

Colonic polyps have a probability of greater than 90% of developing into colon cancer, which is the third most common human malignancy and was the second leading cause of cancer-related deaths in the United States in 2004. It is well accepted that early detection and removal of colonic polyps can dramatically reduce the risk of the death. Currently available polyp detection methods consist of fecal occult blood test, sigmoidoscopy, barium enema, and fiber optic colonoscopy (OC), with the OC currently considered the gold standard. Unfortunately, optical colonoscopy is associated with patient discomfort and inconvenience, which discourage routine screening for colonic polyps.

Computed tomographic colonography (CTC) or CT-based virtual colonoscopy (VC) is an emerging method for polyp detection. VC utilizes advanced medical imaging and computer technologies to simulate traditional optical colonoscopy procedure. In VC, the operator examines the colon for polyps by navigating through a virtual colon-lumen model which is constructed from the patient abdominal images. Previously known systems and methods for performing VC are described, for example, in U.S. Pat. Nos. 5,971,767, 6,331,116 and 6,514,082, the disclosures of which are incorporated by reference in their entireties. VC has the advantage of being a non-invasive procedure which minimizes patient discomfort. Indeed, VC has shown the potential to become a mass screening tool which offers advantages in terms of safety, cost, and patient compliance.

Although it has several advantages as a minimally-invasive screening modality, VC is a time-consuming procedure. For example, even with a state of the art commercial VC navigation system, such as that offered by Viatronix, Inc., Stony Brook, N.Y., it takes more than 15 minutes for a trained radiologist to simulate both forward and backward navigations of the OC procedure. The time can be longer if some suspicious locations need more attention. To reduce the interpretation effort in VC screening procedure, it is highly desirable to employ a computer-aided detection (CAD) scheme.

A CAD scheme that automatically detects the locations of the potential polyp candidates could substantially reduce the radiologists' interpretation time and increase their diagnostic performance with higher accuracy. However, the automatic detection of colonic polyps can be a challenging task because polyps can have various sizes and shapes. Moreover, false positives (FPs) can arise since the colon exhibits numerous folds and residual colonic materials on the colon wall often have characteristics that mimic polyps. A practical CAD scheme for clinical purposes should have the ability to properly identify true polyps and effectively eliminate, or at least substantially reduce, the number of false positives.

### SUMMARY OF THE INVENTION

A computer aided detection method for detecting polyps within an identified mucosa layer of a virtual representation of a colon includes the steps of identifying candidate polyp patches in the surface of the mucosa layer and extracting the volume of each of the candidate polyp patches. The extracted volume of the candidate polyp patches can be partitioned to extract a plurality of features of the candidate polyp patch, which includes at least one internal feature of the candidate polyp patch. The plurality of features of the polyp candidates are analyzed to eliminate false positives from the candidate polyp patches. Those candidates which are not eliminated are identified as polyps.

Preferably, the step of identifying candidate patches includes a step of global curvature analysis. It is also preferred that the step of identifying candidate patches includes a step of local curvature analysis. When both global curvature analysis and local curvature analysis are used, a rules-based analysis to the global curvature analysis and local curvature analysis can be applied to eliminate false positives.

In a preferred method, the step of extracting the volume of the candidate polyp patches involves generating an ellipsoid model of the candidate which includes the visible portion of the polyp candidate as well as the subsurface portion of the polyp candidate. Generating an ellipsoid model of the candidate can be performed by identifying interior border points of an ellipsoid by extending a plurality of rays from visible points of the candidate polyp patches, determining density distributions along the rays, and identifying points on the rays with changes in density which are indicative of a border. Preferably, a Harr wavelet transformation can be applied to the density distributions to identify points on the rays indicative of a border. In generating an ellipsoid model, it is preferable to merge two or more overlapping ellipsoids into a single polyp candidate.

The extracted features of the polyp candidates can include density texture features, morphological features, and geometrical features. In extracting these features, the ellipsoid border is used and a shrunken border and expanded border of the ellipsoid model are also generated. The texture features can be identified by analyzing the region within the shrunken border. The region between the enlarged border and the shrunken border can be analyzed to identify morphological features of the candidate. The ellipsoid border can be analyzed to identify geometrical features.

Preferably, the operation of analyzing the features includes the use of a linear classifier and comparing the output of the linear classifier to a likelihood threshold indicative of a polyp.

### BRIEF DESCRIPTION OF THE DRAWINGS

FIG. 1 is a simplified flow chart illustrating a preferred method of computer aided detection (CAD) of polyps with improved reduction of false positives (FPs), in accordance with the present methods;

FIG. 2 is a simplified flow chart further illustrating a step of identifying candidate polyp patches, in accordance with the present methods;

FIG. 3A is a graphical representation of a uniform kernel function suitable for use in a presently described global curvature method;

FIG. 3B is a graphical representation of a Gaussian kernel function suitable for use in a presently described global curvature method;

FIG. 4 is a table illustrating the relationship between the nine basic classes and modified shape-index values for various mucosa layers;

FIG. 5A is a simplified cross-sectional view illustrating the profile of a polyp extending from the submucosa layer of the colon, as known in the art;

FIG. 5B is an image of a polyp in a CT image slice;

FIG. 5C is a magnified portion of the image of the polyp of FIG. 5B, illustrating a substantially elliptical shape, with a portion of the polyp visible at the surface of the colon lumen;

FIG. 5D is the image of FIG. 5C with a solid line portion highlighting the visible surface portion of the polyp and a dashed line portion showing the sub-surface portion of the polyp;

FIG. 6A is a two dimensional representation of a candidate polyp patch in which a selected voxel is represented as emitting three rays;

FIG. 6B is a graphical representation of the CT density profile along the length of one of the emitted rays in FIG. 6A;

FIG. 6C is a graphical representation of the CT density profile after processing by a Harr wavelet transformation and filtering;

FIG. 6D is an exemplary coding sequence derived from the transformed CT density profile of FIG. 6C;

FIG. 6E is the 2D CT image of FIG. 6A further showing the detected border points in the candidate polyp patch from each of the rays illustrated in FIG. 6A;

FIG. 7 is a simplified block diagram of an embodiment of the Han wavelet transform and filtering process suitable for use in the present methods;

FIG. 8 is a simplified flow chart illustrating the process of partitioning the volume of each polyp candidate to identity features used in the reduction of false positives;

FIG. 9A is a 2D image of a polyp in a CT image, with the visible portion of the polyp highlighted;

FIG. 9B is the 2D image of FIG. 9A, further showing an elliptical model generated using only the points from the visible portion;

FIG. 9C is the 2D image of FIG. 9B, further showing an elliptical model generated in accordance with the present methods using interior points of the polyp candidate;

FIG. 10A is a 2D image of a polyp in a CT image, with the polyp having an irregular visible surface being identified as two visible surface portions;

FIG. 10B is the 2D image of FIG. 10A, and further illustrating elliptical models being generated about each of the two visible surface segments;

FIG. 10C is the 2D image of FIG. 10A illustrating the merger of the two elliptical models of FIG. 10B;

FIG. 11A is a graphical representation of scaling an ellipsoid border of a polyp candidate to establish a shrunk border and an enlarged border;

FIG. 11B is an image from a 2D CT image slice illustrating an ellipsoid border, an enlarged border and a shrunk border about a polyp candidate;

FIG. 12A is a graph illustrating density variation in two dimensions of two vectors, PA(1,2) versus PA(2,3), in accordance with the present methods;

FIG. 12B is a graph illustrating density variation in two dimensions of two vectors, PA(1,2) versus PA(1,3), in accordance with the present methods;

FIG. 12C is a graph illustrating density variation in two dimensions of two vectors, PA(1,3) versus PA(2,3), in accordance with the present methods;

FIG. 12D is a graph illustrating density variation in three-dimensions of vectors, PA(1,2), PA (1,3) and PA(2,3), in accordance with the present methods;

FIG. 13A is an illustration of a mapping procedure of the ellipsoid surface of a polyp candidate employing octsphere parameterization;

FIG. 13B is an illustration of a gradient ray emitted from the center of the octsphere representation of FIG. 13A through a representative patch of the model, such that a CT density profile along the rays can be determined;

FIG. 13C is a pictorial representation of a patch in the octsphere model being marked, indicating the presence of a border within the given search range;

FIG. 13D is a pictorial representation of the octsphere model being fully marked;

FIG. 13E is a pictorial representation of a “patch pair” identified on the octsphere model;

FIG. 14 is a graphical representation of a normalization transform function suitable for use in the present methods;

FIG. 15 is a simplified block diagram of a two-level classifier suitable for use in the present methods;

FIG. 16 is a simplified flow chart illustrating an exemplary method of training the linear classifier; and

FIG. 17 is a graphical representation of the results from an experimental study of CAD performance for detecting polyps of varying sizes.

### DETAILED DESCRIPTION OF PREFERABLE EMBODIMENTS

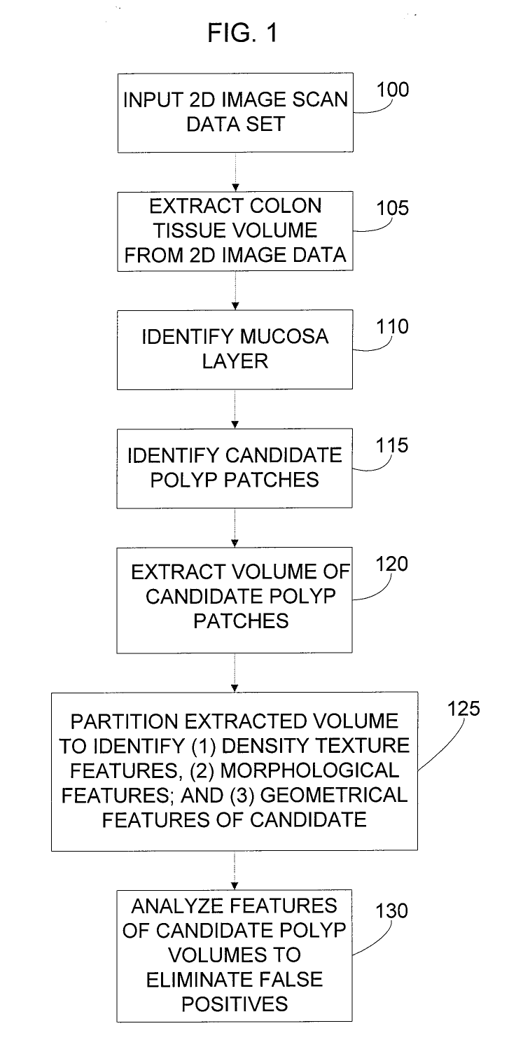

An overview of a preferred embodiment of the present method for computer aided detection (CAD) of polyps with enhanced false positive reduction is shown in the simplified flow chart of FIG. 1. The method assumes that appropriate 2D image data has been acquired, such as through the use of a spiral CT scan or other suitable method known in the art of virtual colonoscopy (step 100). From the 2D image data, the volume of the region of interest, such as the colon, is extracted in step 105, in a manner generally known in the art. After the colon volume has been extracted, a mucosa layer is identified on the interior of the colon lumen (step 110). Within the identified mucosa layer, a set of suspected polyps, or candidate polyp patches, is then identified 115. For each candidate polyp patch identified in step 115, the volume of the patch region is extracted 120. The extracted volume is then partitioned in step 125 in order to identify density texture features, morphological features and geometrical features of the candidate patches. The set of identified features is then analyzed for each candidate patch to eliminate false positives 130.

With respect to image data acquisition of step 100 and the extraction of the colon lumen from this image data in step 105, these operations are generally well known in the art. Suitable techniques for performing image acquisition and segmentation are described, for example, in U.S. Pat. No. 6,514,082, entitled “System And Method For Performing A Three-Dimensional Examination With Collapse Correction,” which is hereby incorporated by reference in its entirety. In one exemplary embodiment, abdominal CT images can be acquired using a single-slice spiral CT scanner; such as model HiSpeed CT/i, from GE Medical Systems, Milwaukee, Wis. Prior to obtaining the CT images, the patients typically undergo a one- or two-day bowel preparation of low-residue diet and mild laxatives. In order to enhance the CT density of the residual colonic materials, the patients can also ingest three to four (depending on one- or two-day preparation) 250 cc doses of 2.1% w/v barium sulfate suspension with meals before the CT procedure, as well as two doses of 60 cc of gastroview (diatrizoate meglumine and diatrizoate sodium solution) given during the night before and the morning of the CT procedure. The preparation may be extended to three days. Preferably, the patients' colons are inflated with CO₂ or room air (2-3 L) given through a small rectal tube, and the CT images are then obtained using routine clinical CT protocols for VC procedure. Imaging protocol parameters found useful in the practice of the present methods include: 120 kVp, 100-200 mA (depending on body size), 512×512 array size for the field-of-view (FOV) (completely covering the body), 1.5-2.0:1.0 pitch, 5 mm collimation (completely covering the entire colon in a single breath-hold), and 1 mm image reconstruction. The 5 mm collimation sets the upper resolution limitation. By a pitch in the range of [1.5, 2.0], the image resolution is limited to 4 to 5 mm. The image resolution and acquisition speed can be improved by using a multi-slice spiral CT scanner.

The identification of the mucosa layer in step 110 may be proceeded by digital cleansing of the colon, which is preferably performed by having a patient ingest an oral contrast agent prior to scanning such that colonic material is tagged by its contrast values. The colon can be electronically “cleansed” by removal of all tagged material, so that a virtual colon model can be constructed.

Preferably, a partial volume image segmentation approach is employed to identify the layers, quantify the material/tissue mixtures in the layers and restore the true CT density values of the colon mucosa layer. Preferably, an iterative partial volume segmentation algorithm, as described in the article “An Improved Electronic Colon Cleansing Method For Detection of Colonic Polyps by Virtual colonoscopy,” by Wan et al., IEEE transactions on Biomedical Imaging 2006, which is incorporated herein in its entirety by reference, can be applied. This technique is also described in a PCT application filed concurrently herewith, entitled “ELECTRONIC COLON CLEANSING METHOD FOR VIRTUAL COLONOSCOPY,” the disclosure of which is also incorporated by reference in its entirety. In this method, the voxels in the colon lumen are classified as air, mixture of air with tissue, mixture of air with tagged materials, or mixture of tissue with tagged materials. The interface layer can then be identified by applying the dilation and erosion method. CT density values of the colon tissues in the enhanced mucosa layer can be restored, such as by the equations and methods described in Wan et al. After this step, a clean and segmented colon lumen is obtained and the mucosa layer is identified 110.

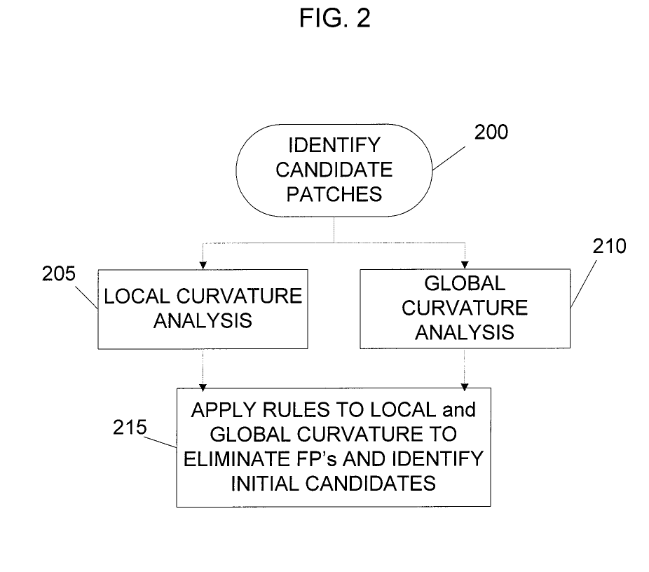

Following the identification of the mucosa layer, the mucosa layer is analyzed to identify candidate polyp patches 115. As illustrated in FIG. 2, the process of identifying candidate polyp patches 115 preferably involves two operations; global curvature analysis 205 and local curvature analysis 210. A rules-based approach is then used to evaluate the global curvature features and local curvature features to eliminate certain false positives and establish a set of initial polyp candidates 215.

The process of global curvature analysis of step 205 is now discussed in further detail. Previously, principal curvature and corresponding curvature measures, such as the mean curvature and Gaussian curvature have been investigated for use in polyp detection. Since the curvatures reflect the shape “tendency” or trend among voxels within a local neighborhood, these measures can be very sensitive to the shape change of the iso-surface at a given position. Therefore, curvature-based shape measures can efficiently detect specific shape-based section of the colon wall. However, the locality property of the curvatures will sometimes mislead the shape detection due to noise and other distortions, resulting in an undesirably high false positive rate. In order to overcome this limitation, a smoothed principal curvature, which is based on the Gaussian curvature, is employed to reflect a more general “tendency” or trend, which can provide an overall shape description of a wider surrounding region. The traditional Gaussian curvature is referred to herein as “local curvature” and its associated direction is called “local principal direction,” while the smoothed curvature is referred to herein as “global curvature.”

Given a non-umbilic point x₀ in a segmented 3D colon mucosa layer, there exist two orthogonal local principal directions. Along each local principal direction, a 3D convolution curve from point x₀ is generated. A convolution curve l_{c} is defined as a curve starting from point x₀ and going both forward and backward in the 3D principal direction field. For each point xₙ on l_{c}, the gradient direction of l_{c} at xₙ is parallel to the local CT density-based principal direction at xₙ. The curvature of l_{c} at xₙ is equal to the corresponding local CT density-based principal curvature at xₙ.

The concept of a convolution curve is used in the present method. Along each (a total of two) convolution curve starting from x₀, a smoothed or global curvature C^{new} is calculated by a convolution along this convolution curve:

$${C}^{new} = \frac{{\int }_{x = {x}_{0} - L}^{{x}_{0} + L} k ( x ) 〈 {g}_{0} \cdot {g}_{x} 〉 {C}_{x} d x}{{\int }_{x = {x}_{0} - L}^{{x}_{0} + L} k ( x ) 〈 {g}_{0} \cdot {g}_{x} 〉 d x} \qquad ( 1 )$$

where L is a half curve length of the convolution curve, k(x) represents the convolution kernel function, gₓ is the gradient vector at point x, g₀ is the gradient vector at point x₀, Cₓ represents the corresponding local curvature at point x, and < > indicates the inner product of two vectors.

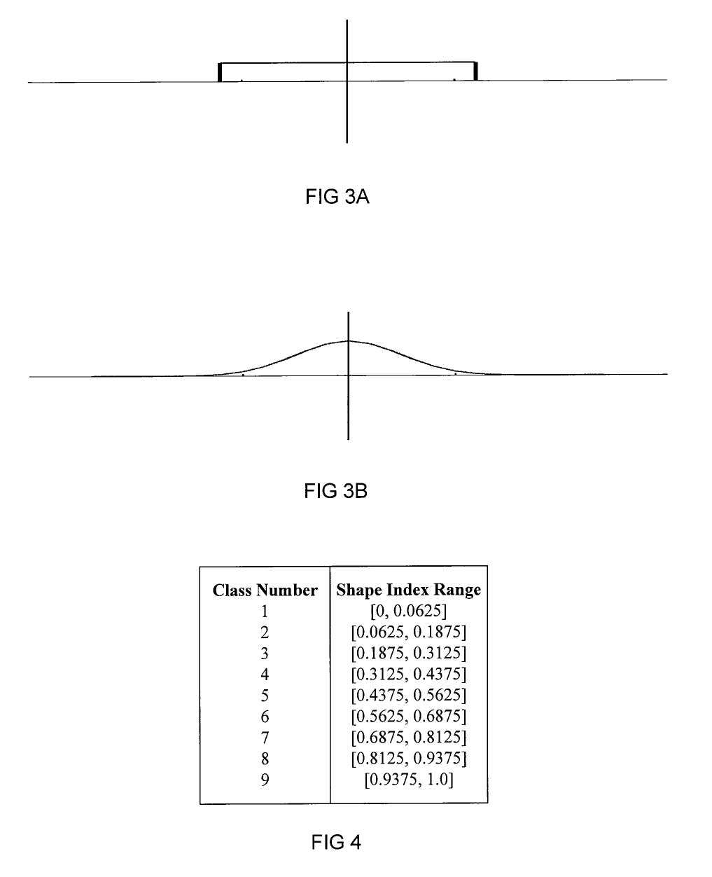

The convolution kernel function plays an important role in generation of the global curvature. By applying different convolution kernel functions, the global curvature can provide different shape information for different purposes. Two typical kernel functions which are applicable in the present methods include a uniform kernel function, which is illustrated in FIG. 3A, and a Gaussian kernel function, as shown in FIG. 3B.

The uniform kernel function is a simple and widely used convolution kernel function. This kernel function has one parameter: the line length. With a short line length, the uniform kernel is usually more suitable for detection of small polyps than with a long line length. With a longer line length, the global curvature with uniform kernel is less sensitive to the shape change of the colon wall. Thus, a longer line length is well suited for the detection of larger polyps, but it may overlook smaller polyps. Given a polyp size threshold, an appropriate line length can be determined. Use of a line length that is 1.5 times larger than the polyp's diameter can achieve acceptable performance according to experimental results. Since polyp size cannot always be accurately anticipated in actual cases, a line length of 15 mm may be an appropriate length in most cases.

Similar to the uniform kernel function, the Gaussian kernel function is also controlled by a single parameter, which is referred to as the alpha value. A property of the Gaussian kernel is its capability to retain some of the “original” shape information. As compared to the uniform kernel, the global curvature using the Gaussian kernel can retain more detectable shape information of small polyps, which makes the Gaussian kernel beneficial for the detection of small polyps. However, retaining too many shape details in the global curvature may reduce the efficiency of CAD methods.

Equation (1), set forth above, is an expression of the global curvature along the corresponding principal direction. For each voxel in the segmented colon mucosa layer, there exist two global curvatures along the two principal directions, respectively. Applying these two global curvatures to the curvature-based measures, such as shape index, curvedness, sphericity rate, etc, corresponding global curvature-based shape measures can be obtained.

A preferred method for performing the step of local curvature analysis of step 210 (FIG. 2) is now described in further detail. Colonic polyps are generally expected to exhibit an elliptic curvature of the peak subtype, which suggests that the shape at the top section of a regular polyp is more likely to present a “spherical cup” or “trough” shape. Correspondingly, the local shape-index values of the image voxels are expected to increase smoothly from the top section to the bottom section of the polyp on the colon wall inner surface.

For some irregular polyps without a smooth surface, the shape-index values vary from the top to the bottom sections in a significantly unsmooth manner as compared to that of regular polyps. As a result, it may be difficult to identify a complete protuberance section from the colon wall based only on the local geometrical shape information. However, by including a modified shape-index measure, which is derived from a smoothed version of the local curvatures as described above, the difficulty can often be mitigated and a complete protuberance section of an irregular polyp candidate can be detected. Based on both the traditional and the modified local shape-index measures, a clustering algorithm can be applied to find suspicious areas or patches on the segmented colon mucosa layer. A preferred clustering algorithm employs a growing-and-merging algorithm. Taking advantage of space connectivity of the voxels, the preferred clustering algorithm clusters all the concerned voxels into several groups as detailed below.

Initially, all voxels in the mucosa layer are labeled into nine basic classes according to their traditional and modified shape-index values. The definitions of all nine classes are shown in FIG. 4. Although nine basic classes are sufficient to cover the whole range of the shape index values and is preferred, more or fewer classes may be employed. In FIG. 4, Class 1 corresponds to the peak type and class 9 to the valley type. If one voxel is labeled into class i, where iε(1, 9) is referred to as the class number of this voxel, then this voxel is called as an i-class voxel. The clustering step for growing-and-merging obeys the following three rules:

Rule 1: A suspicious patch group starts to grow at an i-class voxel, where i is the smallest class number among the class numbers of all the voxels in that group.

Rule 2: If an i-class voxel is clustered into a suspicious patch group, only its non-clustered adjacent voxels, whose class numbers are equal to or greater than i but less than or equal to max_class number, can be clustered into this group in the next clustering step, where the max_class number is chosen based on the polyp size threshold.

Rule 3: If two suspicious patch groups meet each other in space, they can merge into a larger suspicious patch if they satisfy the following two criteria:
a. The number of the bordering voxels between these two groups is not too small (e.g., not less than 10% of the total voxel number in that candidate); and
b. The maximum class number of the bordering voxels is close to the class number of one group's starting-growing voxel.

Rule 1 is intended to operate such that each suspicious patch exhibits a somewhat spherical top section. Rule 2 is intended to operate such that each suspicious patch contains as many available voxels as possible under the max_class number threshold, which corresponds to a shape index threshold. By applying Rule 3, each final suspicious patch can contain the protuberance section as completely as possible.

The clustering algorithm is sensitive to small changes on the colon mucosa layer and can generate over a hundred suspicious patches in a colon dataset. In general, these suspicious patches can be classified into three basic categories: (1) true polyps; (2) patches due to “noise”; and (3) patches due to colon folds and residual colonic materials. The patches due to “noise” occur because of the system scan protocol (such as limited number of X-rays, finite spatial resolution, patient motion, etc). The patches due to colon folds and residual colonic materials occur primarily because the folds and colonic residues mimic the characteristics of true polyps. Both the noise candidates and the mimicking suspicious patches are called misclassifications. In order to improve the classification operation, a series of simple filters are employed to remove, or at least substantially reduce, the occurrences of misclassifications.

By setting the clinically relevant colonic polyps (e.g., larger than 4 mm in diameter) as the threshold and because the suspicious patches due to noise usually have a smaller size or smaller spherical top section, a first detecting filter is stated as follows.

Filter 1: If the total surface area of a suspicious patch is smaller than a given threshold, this suspicious patch is a misclassification. If the ratio of areas of the continuous spherical top section by both the traditional to the modified local geometrical measures is smaller than a given threshold, this suspicious patch is a misclassification.

In one embodiment, the threshold can be set at 15 mm² and the minimum sphere ratio of the traditional and the smoothed local curvature measures on the detected patches can be 25%, which insures no false negatives.

Since the sizes and spherical top sections of candidates mimicking polyps are somewhat similar to those of the true polyps, the application of Filter 1 alone may not eliminate all of these candidates. To further address misclassification of candidates, a General Shape (GS) measure can be defined and applied. A GS measure can be applied as follows: Given a polyp candidate B {voxelᵢ|i=1 . . . |B|}, its GS can be defined as:

$$GS = \frac{1}{2} - \frac{1}{π} arctan \frac{{K}^{mean}}{{K}^{differ}} , \\ GN = \frac{{\sum }_{i = 1}^{\vert B \vert} {g}_{i} \cdot \vert {K}_{i}^{1} + {K}_{i}^{2} \vert}{{\sum }_{i = 1}^{\vert B \vert} \vert {K}_{i}^{1} + {K}_{i}^{2} \vert} \\ {K}^{mean} = {\sum }_{i = 1}^{\vert B \vert} ( {K}_{i}^{1} + {K}_{i}^{2} ) \cdot 〈 {g}_{i} \cdot GN 〉 , \\ {K}^{differ} = {\sum }_{i = 1}^{\vert B \vert} ( {K}_{i}^{1} - {K}_{i}^{2} ) \cdot 〈 {g}_{i} \cdot GN 〉 \qquad ( 2 )$$

where gᵢ is the gradient at voxel i, Kᵢ¹ and Kᵢ² are the principal curvatures (with Kᵢ¹≧Kᵢ²), and < > represents the inner product of two vectors.

If the local curvature definition (for Kᵢ¹ and Kᵢ²) is used for equation (2), a local GS measure is obtained which provides information of what the candidate “looks like.” If the smoothed curvature definition of equation (1) is used, a “global” GS measure is obtained, which gives an overall shape description of the candidate around its surroundings. Based on both the local and the global GS measures, a second detecting filter can be applied as follows:

Filter 2: A classified suspicious patch, whose local and global GS measures do not reflect

a spherical cup or trough shape, is a misclassification.

In one embodiment, GS values of 0.25 for both the local and global GS measures can be used, which insures no false negatives.

It is noted that both the traditional and the smoothed local curvatures have complementary properties, as described above. Therefore, the combination of both the traditional and the modified local shape measures in these filters is expected to reduce the number of misclassifications.

The suspicious patches which are not removed as a result of the application of Filter 1 and Filter 2 are now referred to as the initial candidates.

It has been previously shown that polyp-like false suspects are not completely eliminated by the use of surface shape-based measures only. Therefore, it is desirable to apply information beyond the colon wall inner surface in order to further reduce the number of false positives. In the present method, for the set of initial candidates identified in step 215, the inner border of each candidate is identified such that the volume of each of the initial candidates can be extracted in step 120, which is now described.

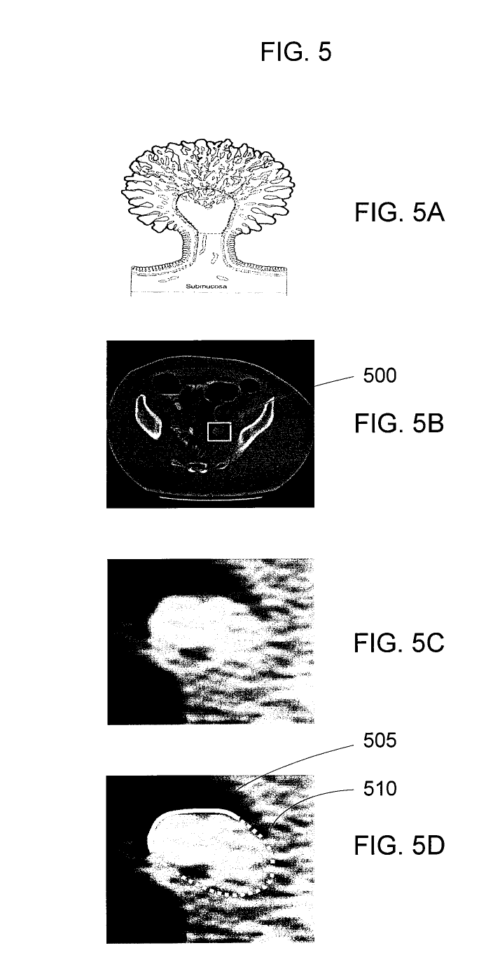

Based on an understanding of general polyp pathology, as shown in FIG. 5A, and the assumption that the detected initial candidates exhibit an “elliptical” volume shape, as shown in FIG. 5B and FIG. 5C, an ellipsoid model is constructed which substantially matches the suspect volume. Typically, the whole border of the ellipsoid consists of two parts: the outer part 505, which is visible in the colon lumen, and the inner portion 510 which is behind the colon wall inner surface. The outer border 505 in the mucosa layer can be detected as the suspicious patch, as described above. The inner border 510 lies between the suspect and its adjacent normal tissues, as shown in FIG. 5D. A first approach to constructing an ellipsoid is to grow the detected outer portion into the mucosa layer and possibly the colon wall until some thresholds are satisfied. Another way is to find the inner border points and fit the inner points together with the outer portion into an ellipsoid. The latter approach is further described below.

Based on the 3D convex ellipsoid model, a ray emitted from a point on the outer border will intersect with the inner border at least once in most cases. Taking advantage of this geometrical attribute of the border points, a ray-driven technique to search for the inner border points in the CT image can be applied. Given a voxel ν in an initial candidate, the image density gradient at that voxel is computed as (gₓ^{ν},g_{y}^{ν},g_{z}^{ν}). From this voxel, up to four rays are emitted whose directions are defined as:

$${Ray}_{x} = ( - SIGN ( {g}_{x}^{v} ) , 0 , 0 ) \\ {Ray}_{y} = ( 0 , - SIGN ( {g}_{y}^{v} ) , 0 ) \\ {Ray}_{z} = ( 0 , 0 , - SIGN ( {g}_{z}^{v} ) \\ {Ray}_{grad} = ( - {g}_{x}^{v} , - {g}_{y}^{v} , - {g}_{z}^{v} ) \\ where \\ SIGN ( t ) = \{ \begin{matrix}1 & t > 0 \\ 0 & t = 0 \\ - 1 & t < 0\end{matrix} \qquad ( 3 )$$

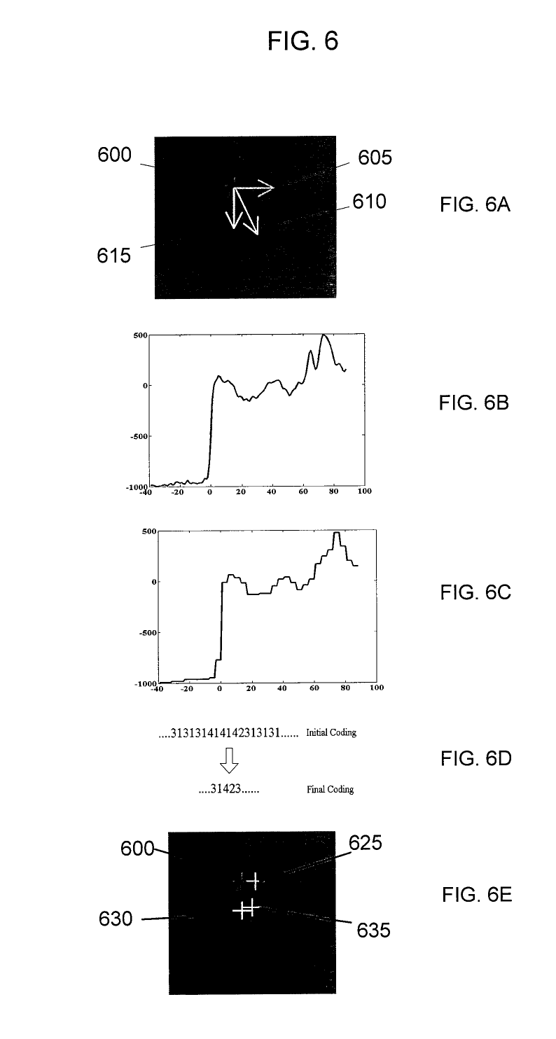

This is further illustrated in FIG. 6A, with ray 605, 610 and 615 being emitted from a voxel 600 on the visible portion of the border.

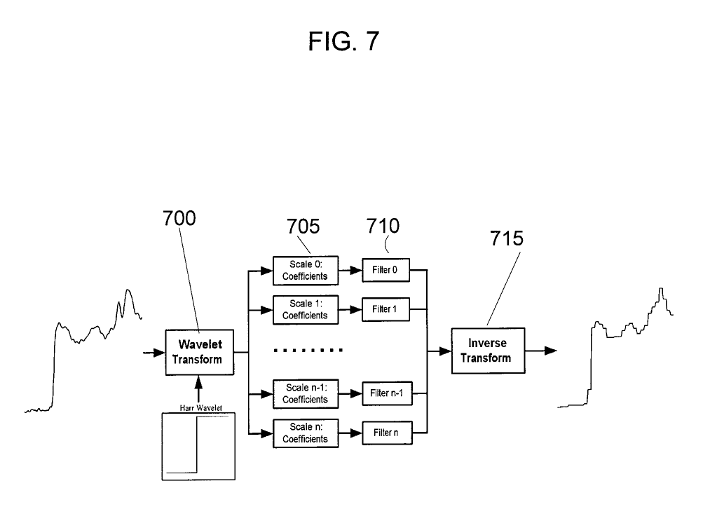

According to the elliptical geometrical attribute, there exists another border point along each ray. To identify this border point, a wavelet-based edge detector can be used. Firstly, a CT data profile along the length of each emitted ray is generated, such as illustrated in the graph of FIG. 6B. Using a Harr wavelet transformation on the CT profile, which is described in G. Strang and T. Nguyen, Wavelets and Filter Banks, Wellesley-Cambridge Press, 1996, a series of wavelet coefficients under different scales can be extracted. In the present method, the length of the CT data profile is chosen as 128 voxel units so as to cover a relatively long range, thereby ensuring coverage to the inner border point. In this case, the highest wavelet scale is 7. After removing the high-scale (high-frequency) coefficients, e.g., 5 to 7, and performing inverse-transformation, the original CT profile of FIG. 6B is transformed to a stepwise-like profile, as shown Figure in 6C. More detailed operation between FIG. 6B and FIG. 6C is illustrated in the simplified block diagram of FIG. 7.

Referring to FIG. 7, the CT density profile is applied to the input of a Harr wavelet transform 700. The output of the wavelet transform 700 is applied to a set of n channels, each of which include a respective scaling operator 705 and filter 710. The n channels are then recombined in the input of an inverse transform 715. The output from the inverse transform operation is the step-wise profile of FIG. 6C.

The step-wise like profile of FIG. 6C can be represented by a numeric coding procedure. The numbers 1 to 4 can be used to represent a four-step status in the new profile, with 1 representing a short plane, 2 representing a long plane, 3 representing a jump up, and 4 representing a jump down. Through a merger of the smaller steps, the profile can be transformed into a number series, as illustrate in FIG. 6D. Since a typical border point has a specific variance pattern which can be represented by a number pattern, such as “423,” “2413,” and so on, it is easy to identify this pattern from the profile's number series and thus identify a border. Usually the transformed profile provides an approximated location, instead of an exact position. The first- and second-order derivatives of the original profile can then be used to identify the final position of the border point around the approximated location.

Because of image noise and other artifacts, some of the detected border points may not represent actual points on or near the inner border. To avoid such false border points, a search distance range for each ray can be defined. An exemplary search range can be defined quantitatively by the curvedness at the starting voxel ν. Only those border points identified by the edge finder within this search range or curvedness are treated as the inner border points. FIG. 6E shows an example of the original point 600 along with identified border points 625, 635 and 630, which correspond to rays 605, 610 and 615, respectively.

Given the identified inner and outer border points, a 3D ellipsoid region of interest (eROI) can be generated using the minimum algebraic distance fitting category of the form:

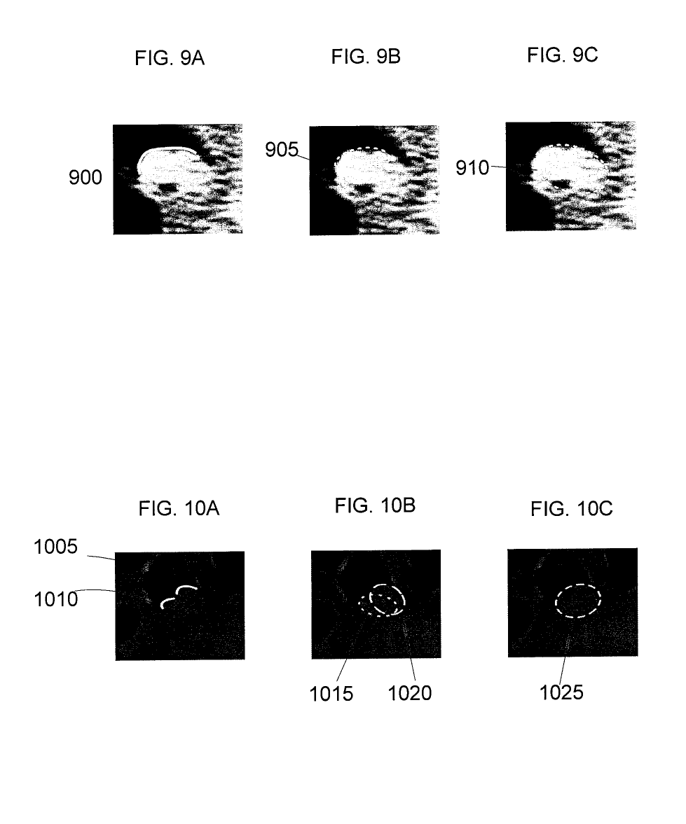

x^{T}Ax+b^{T}x+c=0,AεR^{3×3},x,bεR³,cεR (4)

where mathematical conventional notations have been used. FIGS. 9A through 9C and FIGS. 10A through 10C show examples of constructing the ellipsoid model by equation (4) given the inner and outer border points. In most cases, a single solid curve can cover all outer border points of a polyp candidate through shape analysis on the detected patch, as illustrated in FIGS. 9A through 9C. However, there are some cases where the whole outer border can be divided into several separated parts due to noise and other artifacts, as shown in FIGS. 10A through 10B. These parts may lead to several different eROIs. To address this possibility, a “merge” operation, shown in FIG. 10C, can be employed. For example, if two ellipsoids intersect each other and the intersecting region consists at least 50% of the total volume in one ellipsoid, then all the outer border points and the inner border points of these two candidates will be merged. A new ellipsoid will then be generated using equation (4) for a new “merged’ candidate, as shown in FIG. 10C.

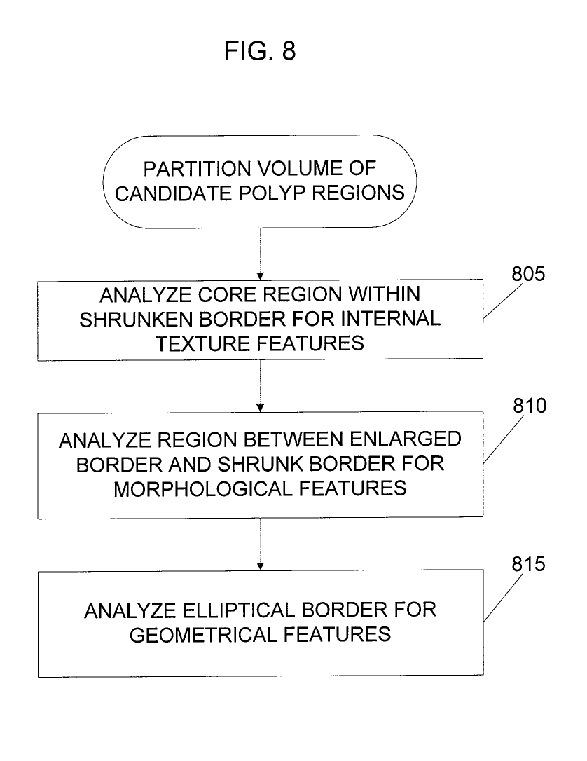

After the volume of each candidate polyp patch is extracted, the extracted volume is then analyzed for a variety of features. In one embodiment further illustrated with reference to FIG. 8, based on the eROI model, three types of features are extracted for further reduction of the FPs in the detected initial candidates after the surface shape-based measures or filters: geometrical (step 815), CT density distribution or texture (step 805), and morphological features (step 810). The order of these feature extraction operations is not critical. Each feature type is detailed in the following sections.

### Geometrical Features

As illustrated in step 815, the identification of geometrical features is performed in connection with step 125. A polyp generally has at least two typical geometrical attributes in the CT images, which are the shape change on the colon mucosa layer and the elliptical-like volume in 3D space. The shape change on the mucosa layer has been described above for the detection of the initial candidates. From a constructed eROI for each initial candidate, two geometrical features can be extracted which are referred to herein as: Volume and Axis_Ratio. In this regard, the three radii of the eROI are identified as axis₁, axis₂ and axis₃, (where axis₁>=axis₂>=axis₃), and the definition of the Volume and Axis_Ratio can be expressed as:

$$Volume = \frac{4}{3} π \cdot {axis}_{1} \cdot {axis}_{2} \cdot {axis}_{3} , \\ Axis\_Ratio = \frac{{axis}_{3}}{{axis}_{1}} . \qquad ( 5 )$$

The Volume and Axis_Ratio are two geometrical features that can be used to describe the shape of the eROI. In some CAD applications, only polyps with a size greater than 4 mm in diameter are considered. In such a case, an eROI with too small Volume exhibits too low of a probability to be a true polyp. The Axis_Ratio provides another shape description of the eROI. Prior research notes that a “typical” polyp may have a sphere-like shape, although many polyps will have a deformed shape for a variety of reasons. However, the deformation may not change the shape dramatically. Therefore, it is expected that a true polyp will have a larger Axis_Ratio value, while the FPs from the colon folds and residue colonic materials will have a small Axis_Ratio value in their corresponding eROIs. Thus an eROI with larger Axis_Ratio indicates a higher probability of being a true polyp.

### CT Density Distribution—Texture Features

Besides the eROI geometrical features, the CT density distribution within the eROI reflects another feature of the initial candidate that can be used in connection with step 125. It has been recognized that polyps generally exhibit less image-density uniformity than normal colon tissues. Furthermore, the image density variation within the polyps may exhibit a specific pattern, which can also be utilized as an indicator for polyp identification. In the following, a 3D texture measure is described for the density variation pattern.

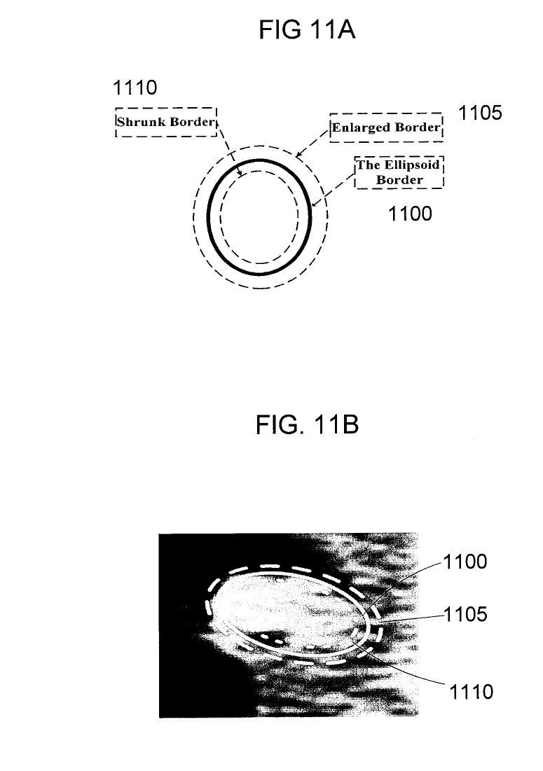

Due to the subtle change of CT density values from a polyp region to its neighborhood, it is desired to minimize the effect from the adjacent tissues. Referring to FIG. 11, the extracted eROI 1100 can be enlarged and shrunk using an erosion and dilation method, such as by using a fixed scale, to obtain two borders, which are referred to as an Enlarged Border 1105 and a Shrunk Border 1110. This is also illustrated in the 2D CT image of FIG. 11B. For example, a scale factor of 0.70 can be used to establish the shrunk border 1110 and a scale factor of 1.3 can be used for the enlarged border 1105. It is expected that the derived density or texture features from voxels within the shrunk border 1110 exhibit more stability because of less effect from the adjacent tissues. Therefore, in the present method, it is preferred that all the texture features are derived from the voxels within the shrunk border.

Given a voxel ν within the shrunk border 1110 of an eROI, three eigenvalues from its Hessian matrix can be obtained. Without loss of generality, the three eigenvalues are λ₁, λ₂, and λ₃ (with |λ₁|≧|λ₂|≧|λ₃|). For each pair of eigenvalues (λᵢ, λⱼ), the corresponding pattern parameters PA_{i,j} can be calculated by:

$${PA}_{i , j} = - \frac{2}{π} arctan ( \frac{{λ}_{i} + {λ}_{j}}{\vert {λ}_{i} - {λ}_{j} \vert} ) , \{ i , j \vert i , j ∈ \{ 1 , 2 , 3 \} , i \neq j \} . \qquad ( 6 )$$

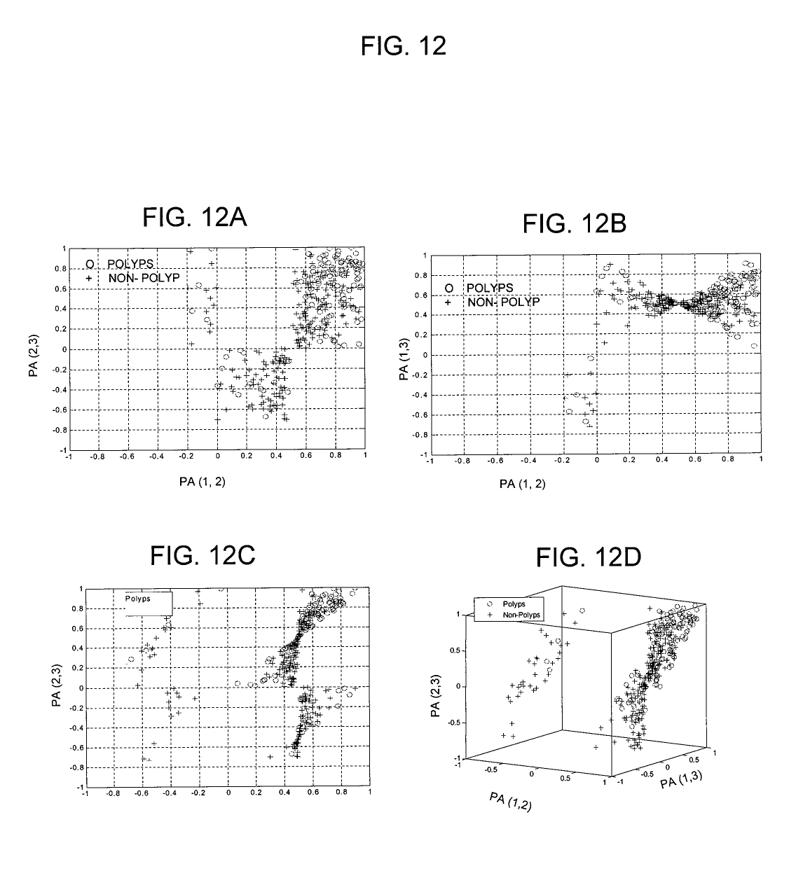

Thus, for each voxel, a triple-element vector <PA_{1,2}, PA_{1,3}, PA_{2,3}> is obtained which represents the density variation pattern around that voxel. By plotting the triple-element vectors in 2D/3D space, it is observed that the vector from each polyp voxel shows a different distribution pattern from that of a non-polyp voxel, as shown in FIGS. 12A through 12D. The polyp voxels show a converging attribute toward the top right in the plots (denoted by the circles), while the voxels of FPs from the colon folds and residue materials (denoted by the crosses) do not exhibit this converging attribute.

It is expected that the density values within a polyp change gradually and smoothly from the center to its border. This attribute is reflected by the convergence of the triple-element vectors toward the corner (1.0, 1.0, 1.0) in the 3D presentation of FIG. 12D. Based on the observed converging attribute, a texture feature of Growth_Ratio can be introduced as follows:

$${Growth\_Ratio}_{i} = \frac{\vert {S}_{i}^{g} \vert}{\vert {S}_{i} \vert} \qquad ( 7 )$$

where Sᵢ={voxel ν|ν is located within the shrunk border of eROI i}; Sᵢ^{g}={voxel ν|ν is located within the shrunk border of eROI i and its triple-element vector is located at a 3D boundary as defined by, e.g., [0.5:1.0; 0.5:1.0; 0.5:1.0] in FIG. 12D}; and symbol ∥ indicates the number of voxels in the set.

For a polyp candidate, the Growth_Ratio reflects the density distribution pattern within its eROI. As the Growth_Ratio approaches 1.0, the density variation pattern of this candidate indicates a good match to the typical pattern of true polyps. The lower the Growth_Ratio, the less likely this candidate will be a true polyp. Besides the Growth_Ratio, the CT mean density value may be another useful internal feature to distinguish the real tissues from FPs caused by tagged or enhanced residues. Although the mean density value cannot provide precise quantitative measurements of the density information, it may reflect a feature that can be used to differentiate the FPs. For example, the mean density value of the FPs caused by colonic residues may have a set value of 300 to 800 HU because the enhancement capabilities vary among different oral contrast solutions. Meanwhile, the mean density value of real polyps may only range from −350 to 50 HU. Therefore, the FPs caused by enhanced colonic residue may be differentiated from the real polyps by using the simple threshold established by the differing ranges of the mean density values.

### Morphological Features

As discussed above, a typical polyp has a relatively complete border in the CT image. This border results from the difference between polyp cells and the surrounding normal tissue cells. In contrast, the colon folds and/or other normal colon tissues seldom show a relatively complete border due to the similarity between their CT densities. Applying this attribute, two morphological features referred to as Coverage_Ratio and Radiation_Ratio can be introduced to provide a quantitative measure of the border for each eROI.

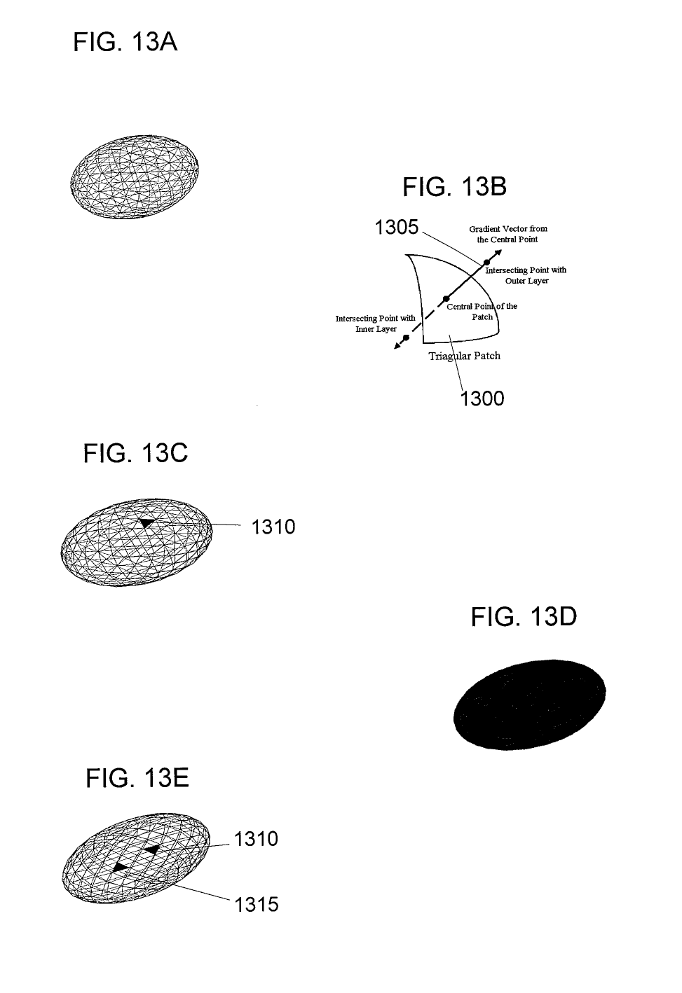

First, as shown in FIG. 13A, the entire eROI border is divided into several regular patches by parameterization of an octsphere, as described in the article Z. Wang and Z. Liang, “Sphere light field rendering”, SPIE Medical Imaging, vol. 4681, pp. 357-365, 2002, the disclosure of which is incorporated by reference. For each patch 1300 on the eROI border, a ray 1305 crossing its center along the normal direction will intersect its shrunk and enlarged borders (1110, 1105, FIG. 11) respectively. Similar to the ray-driven edge finder described above, a CT density profile along this ray 1305 is generated. If a border point is detected between the shrunk and enlarged borders, this patch is marked 1310, as shown in FIG. 13C.

Given a patch on the eROI border, there is another patch where the line between these two patches' center points crosses the center of the eROI. These two patches 1310, 1315 are called a patch pair, as shown in FIG. 13E. If two patches in a patch pair are both marked, this pair is referred to as a marked patch pair. Given an eROI, let PP and PPₚₐᵢᵣ be the set including all patches and all patch pairs respectively, two morphological features of this eROI can be defined as:

$$Coverage\_Ratio = \frac{\vert {PP}^{marked} \vert}{\vert PP \vert} , Radiation\_Ratio = \frac{\vert {PP}_{pair}^{marked} \vert}{\vert {PP}_{pair} \vert} \qquad ( 8 )$$

where PP^{marked} and PPₚₐᵢᵣ^{market} are in a marked patch set; and ∥ indicates the number of voxels in the set.

The Coverage_Ratio provides a quantitative measure for the border coverage information of the eROI. An eROI with a larger Coverage_Ratio must have a more complete border. The Radiation_Ratio there reflects mainly the border distribution information. For example, if an eROI only has a half contiguous border, its Radiation_Ratio will be 0 while its Coverage_Ratio remains 50%.

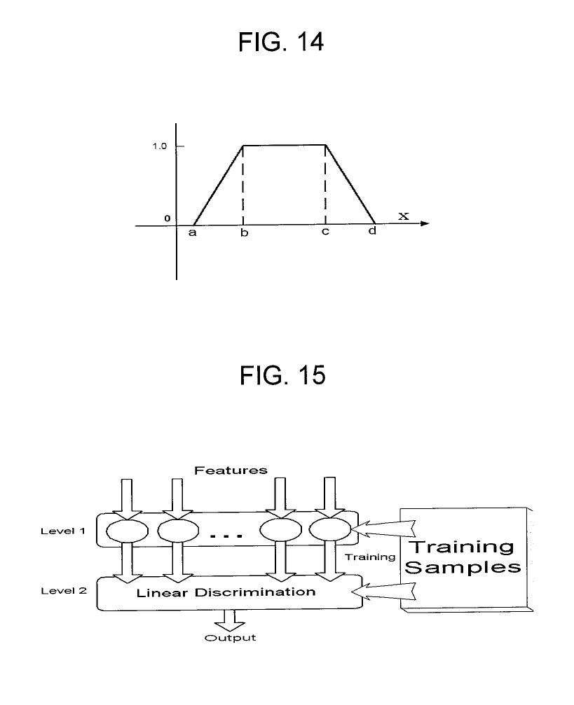

As a result of the operations performed in connection with step 125 described above, there are preferably a total of six internal features extracted from each eROI: Volume, Axis_Ratio, Growth_Ratio, Density_Mean, Coverage_Ratio and Radiation_Ratio. Based on these features, a two-level classifier is then applied in step 130 to reduce the FPs in the set of initial candidates. The preferred classifier consists of two levels. At the first level, each feature is passed through a transformation function, such as illustrated in FIG. 14. After the transformation function, the features enter a linear discrimination at the second level, as shown in FIG. 15. Among the set of features, the Axis_Ratio, Growth_Ratio, Coverage_Ratio, and Radiation_Ratio are four “normalized” features, i.e., their feature values are normalized to the range of [0, 1] so that they can pass through the first level of the transformation function and directly go into the second level of the linear discrimination.

However, the Volume and Density_Mean features are two “non-normalized” features, whose transformation functions are specially designed as follows:

$${φ}_{i} ( t ) = \{ \begin{matrix}0 & t ∈ ( - ∞ , a ) \\ t - a / b - a & t ∈ [ a , b ) \\ 1 & t ∈ [ b , c ] \\ d - t / d - c & t ∈ ( c , d ] \\ 0 & t ∈ ( d , + ∞ ) .\end{matrix} \qquad ( 9 )$$

The transformation function of equation (9) has four parameters to be determined for the Volume and Density_Mean features: a, b, c and d. A preferred approach to determining these parameters uses a learning or fitting strategy. By this strategy, a computer can automatically determine an optimal selection of these four parameters by using training samples. After the transformation, both the Volume and the Density_Mean features are “normalized” in the range [0, 1].

The classifier function for the six internal features in the linear discrimination can be written as follows:

$$F = {\sum }_{i} {w}_{i} \cdot {φ}_{i} ( {f}_{i} ) + η \qquad ( 10 )$$

where φᵢ(.) is the transformation function for feature fᵢ, wᵢ is a weight factor for this feature, η is a constant factor, and i indexes the features. For the four “normalized” features, φᵢ(.)=fᵢ. The weight factors {wᵢ} and constant factor η for all the six internal features are determined by computer learning or fitting strategy using training datasets.

For each feature vector (i.e., the extracted six from an eROI) from a polyp candidate, the linear two-level classifier will output a likelihood or probability value F which is normalized between 0.0 and 1.0. The more closely this value approaches 1.0, the more likely this candidate will be a true polyp. Using an appropriate likelihood threshold, all the candidates can be classified and identified according to their likelihood values from the linear classifier as either polyps or false positives.

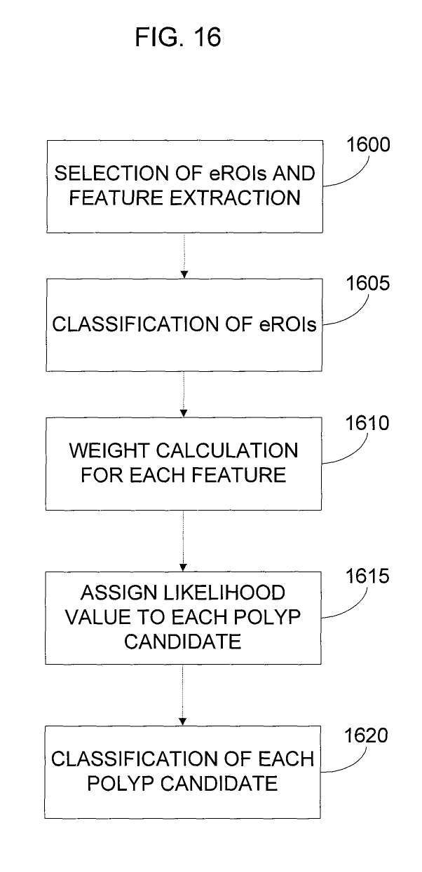

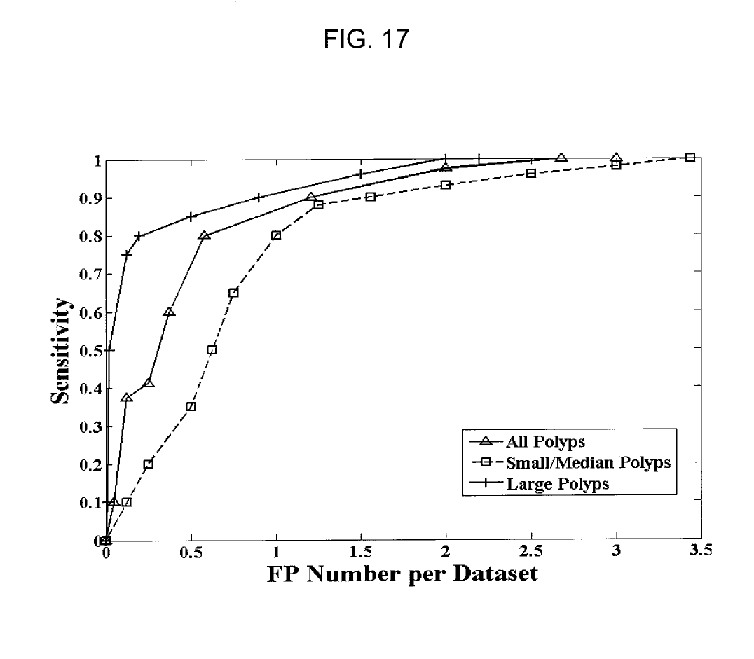

An example of the training process for the linear classifier is illustrated in FIG. 16. Referring to step 1600, all eROIs that contain both real polyps and FPs for training are selected, and each of the six features may be extracted from each eROI: Volume, Axis_Ratio, Growth_Ratio, Density_Mean, Coverage_Ratio and Radiation_Ratio. In step 1605, the eROIs are classified as either FPs or real polyps. If an eROI is a FP, its corresponding target is set to 0; if an eROI is a real polyp, however, its corresponding target is set to 1. Both the six feature designation and the target value may be used as a training sample. In step 1610, after collecting all valid training samples, the weight of the each feature can be calculated by a two-class linear discrimination training method, as known in the art. In step 1615, once all weights are determined, the linear two-level classifier will output a likelihood or probability value F which is normalized between 0.0 and 1.0 for each feature vector (i.e., the extracted six from an eROI) from a polyp candidate. The more closely this value approaches 1.0, the more likely this candidate will be a true polyp. In step 1620, using an appropriate likelihood threshold, all the candidates can be classified and identified as either polyps or false positives according to their linear classifier likelihood values, which are usually the users/physicians select the likelihood threshold. Choosing different thresholds will affect the sensitivity and false positives rate of the whole CAD algorithm. FIG. 17 represents the results from a 153 patient experimental study of CAD performance relating the number of false positives to the sensitivity for polyps of varying sizes.

In the present methods, both shape characteristics and internal features of a polyp candidate are employed to analyze whether a suspicious area represents an actual polyp or a false positive. By employing a number of weighted features extracted from the volume of each candidate polyp, such as texture features, morphological features and geometrical features, improved reduction in false positives can be achieved as compared to using surface features alone.

What is claimed is:

1. A computer-based method of detecting polyps within an identified mucosa layer of a virtual representation of a colon comprising:
identifying candidate polyp patches using surface features of the mucosa layer;
extracting the volume of each of the candidate polyp patches;
partitioning the extracted volume of at least one candidate polyp patch to extract a plurality of features of the candidate polyp patch, including at least one internal feature of the candidate polyp patch;
analyzing the plurality of features to eliminate false positives from the candidate polyp patches; and
identifying candidate polyp patches which are not false positives.

2. The method of claim 1, wherein the step of identifying candidate patches comprises a step of global curvature analysis.

3. The method of claim 2, wherein the step of identifying candidate patches further comprises a step of local curvature analysis.

4. The method of claim 3, wherein the step of identifying candidate patches further comprises applying a rules-based analysis to the global curvature analysis and local curvature analysis to eliminate false positives.

5. The method of claim 1, wherein the step of extracting the volume of the candidate polyp patches further comprises generating an ellipsoid model of the candidate.

6. The method of claim 5, wherein the operation of generating an ellipsoid model of the candidate further comprises:
identifying interior border points of an ellipsoid by extending a plurality of rays from visible points of the candidate polyp patches;
determining density distributions along the rays; and
identifying points on the rays indicative of a border.

7. The method of claim 6, wherein a Harr wavelet transformation is applied to the density distributions to identify points on the rays indicative of a border.

8. The method of claim 5, wherein the generating of an ellipsoid model comprises merging two or more overlapping ellipsoids.

9. The method of claim 1, wherein the plurality of extracted features include at least one of density texture features, morphological features, and geometrical features.

10. The method of claim 5, wherein the plurality of extracted features include at least one of density texture features, morphological features, and geometrical features.

11. The method of claim 10, further comprising the generation of a shrunken border of the ellipsoid model and wherein texture features are identified by analyzing the region within the shrunken border.

12. The method of claim 10, further comprising the generation of a shrunken border of the ellipsoid model and an enlarged border of the ellipsoid model and wherein the region between the enlarged border and the shrunken border is analyzed to identify morphological features of the candidate.

13. The method of claim 1, wherein the operation of analyzing the plurality of features further comprises applying the plurality of features to a linear classifier and comparing the output of the linear classifier to a likelihood threshold indicative of a polyp.

14. A computer-based method of detecting polyps within a virtual representation of a colon comprising:
receiving 2D image data of an abdominal region;
extracting a 3D colon lumen from the 2D image data;
applying partial volume segmentation to identify a mucosa layer of the colon lumen;
identifying candidate polyp patches based on surface features of the mucosa layer;
extracting the volume of each of the candidate polyp patches;
partitioning the extracted volume of at least one candidate polyp patch to extract a plurality of features of the candidate polyp patch, including at least one internal feature of the candidate polyp patch;
analyzing the plurality of features to eliminate false positives from the candidate polyp patches; and
identifying candidate polyp patches which are not false positives.

15. The method of claim 14, wherein the step of identifying candidate patches comprises a step of global curvature analysis.

16. The method of claim 15, wherein the step of identifying candidate patches further comprises a step of local curvature analysis.

17. The method of claim 16, wherein the step of identifying candidate patches further comprises applying a rules-based analysis to the global curvature analysis and local curvature analysis to eliminate false positives.

18. The method of claim 14, wherein the step of extracting the volume of the candidate polyp patches further comprises generating an ellipsoid model of the candidate.

19. The method of claim 18, wherein the operation of generating an ellipsoid model of the candidate further comprises:
identifying interior border points of an ellipsoid by extending a plurality of rays from visible points of the candidate polyp patches;
determining density distributions along the rays; and
identifying points on the rays indicative of a border.

20. The method of claim 19, wherein a Harr wavelet transformation is applied to the density distributions to identify points on the rays indicative of a border.

21. The method of claim 18, wherein the generating of an ellipsoid model comprises merging two or more overlapping ellipsoids.

22. The method of claim 14, wherein the plurality of extracted features include at least one of density texture features, morphological features, and geometrical features.

23. The method of claim 18, wherein the plurality of extracted features include at least one of density texture features, morphological features, and geometrical features.

24. The method of claim 23, further comprising the generation of a shrunken border of the ellipsoid model and wherein texture features are identified by analyzing the region within the shrunken border.

25. The method of claim 23, further comprising the generation of a shrunken border of the ellipsoid model and an enlarged border of the ellipsoid model and wherein the region between the enlarged border and the shrunken border is analyzed to identify morphological features of the candidate.

26. The method of claim 14, wherein the operation of analyzing the plurality of features further comprises applying the plurality of features to a linear classifier and comparing the output of the linear classifier to a likelihood threshold indicative of a polyp.
